(19) United States
(12) Patent Application Publication
(10) Pub. No.: US 2023/0326371 A1
(43) Pub. Date: Oct. 12, 2023

(54) SPHERICAL GEOMETRY APPARATUS

(71) Applicant: Karthikeyan THANGARAJ, Sholinganallur (IN)

(72) Inventor: Karthikeyan THANGARAJ, Sholinganallur (IN)

(21) Appl. No.: 18/025,478

(22) PCT Filed: Sep. 7, 2021
(86) PCT No.: PCT/IN2021/050866

§ 371 Date: Mar. 9, 2023

(30) Foreign Application Priority Data
Sep. 10, 2020 (IN) 202041039145

(51) Int. Cl. G09B 23/04

(52) U.S. Cl. CPC G09B 23/04; G09B 27/08

(57) ABSTRACT

An apparatus (100) for performing spherical geometry is disclosed. The apparatus (100) includes a frame (102) having a base (104) and a sphere set (106) placed on the base (104). The sphere set (106) includes an outer sphere (108) having a transparent surface and an inner sphere (110) having a surface representing a graph template, which includes azimuth and polar angle scales. The inner sphere (110) is held in a default static orientation with reference to the base (104) and is concentric with reference to the outer sphere (108) by a levitating arrangement. The outer sphere (108) is supported on the base (104) and is rotatable in any direction independent of the inner sphere (108) for determining spherical geometry measurements based on the graph template.

### CROSS-REFERENCES TO RELATED APPLICATION

This application claims priority to Indian provisional patent application no. 202041039145 entitled SPHERICAL GEOMETRY APPARATUS filed on 10 Sep. 2020.

### FIELD OF THE INVENTION

The disclosure generally relates to mathematical instruments and in particular to an apparatus for practising spherical geometry and three-dimensional orientation concepts.

### DESCRIPTION OF THE RELATED ART

Geometry is a fascinating subject applied in many technological fields. Topics of geometry include formative content of school mathematics curricula that provide an intuitive and systematic understanding of physical space. The concepts of planar geometry are also applied in various advanced fields of science, engineering, and visual arts. On the other hand, the principles of spherical geometry find use in topics such as terrestrial navigation, air navigation, celestial navigation, spherical trigonometry, point group symmetry, three-dimensional (3D) orientation of objects and rotation operations.

The mathematical geometry instrument set, with tools such as ruler, compass, set squares and protractor are used for practice of planar geometry on a flat paper. However, there is a lack of convenient physical device for constructing geometrical elements on a spherical surface, such as a globe. Spherical geometry is often taught through illustrative two-dimensional (2D) drawings on flat plane or computer screen, but such techniques are non-intuitive and demands good visualization ability. An underlying need exists among geometers and students for a hands-on visual aid to practice spherical geometry and examine 3D orientations akin to a geometry tool set of planar geometry.

Spherical earth globe on a tilted rotating axis stand is a familiar and captivating educational showpiece used at schools, offices, and homes. Prior art information on several variations of globe model systems are known, such as the different structural configuration of stand, rotational freedom or constraints, lighting and motorized arrangements, additional measuring scales or overlays for date or time and celestial tracking. Examples of various embodiments of globe support structure, rotation mechanism, measuring scales and drawing methods are disclosed in U.S. Pat. Nos. 1,175,612A, 2,151,601A, 2,408,651A, JP2002071352A, U.S. Pat. Nos. 2,958,959A, 3,100,353A, 6,612,843B1 and 7,207,803B2. Hungarian Pat. No. 192681 discloses an educational visual aid and device set for constructing geometrical drawings on a sphere. U.S. Pat. No. 9,664,512B2 describes an orientation indicating device comprising of plurality of perpendicular rods and rollers mounted within a spherical enclosure. U.S. Pat. No. 6,937,125B1 discloses a self-rotating spherical display device with the inner sphere floating on a fluid within another transparent sealed sphere. U.S. Pat. No. 3,128,562A describes a magnetic compass device based on double-ball assembly and liquid partially filling the inner ball.

None of the foregoing body of prior art teaches or suggests a comprehensive spherical geometry educational device based on a double-sphere configuration. The prior art also does not teach techniques of retaining a steady default orientation in the inner sphere, so as to utilize its static orientation and its angle graduated surface as the background graph for measuring and drawing spherical angles on the outer transparent sphere. Further, there are no methods or devices known in prior art for depicting 3D orientations or measuring Euler angles on a sphere surface. Further, the prior art also does not provide methods or physical elements for effecting independent rotation so as to bring about a change in 3D orientation of an artefact on a spherical surface.

### SUMMARY OF THE INVENTION

According to one embodiment of the present subject matter, an apparatus for performing spherical geometry is disclosed. The apparatus for performing spherical geometry includes a frame having a base and a sphere set placed on the base. The sphere set includes a thin outer transparent sphere and an inner sphere with a graph template surface of azimuth and polar angle scales. The inner sphere is held in a default static orientation with reference to the base and is concentric with reference to the outer sphere by a levitating arrangement. The outer sphere is supported on the base and is rotatable in any direction independent of the inner sphere for determining spherical geometry measurements based on the graph template.

In some embodiments, the levitating arrangement includes one or more of a predetermined liquid placed within the outer sphere, weights, or a plurality of magnets placed within the inner sphere. In various embodiments, the apparatus may include a semi-circular band element having an angular scale surface, wherein the semi-circular band element is attached to antipodal points of the outer sphere. In some embodiments, the apparatus may include a slidable component movably coupled to the semi-circular band element. In some embodiments, the slidable component may include a pointer hole attachable to a drawing tool, wherein the drawing tool is configured for drawing arced paths of great circles and small circles.

In various embodiments, the semi-circular band element is attached to the outer sphere at a half-tight position to enable encircling motion on the outer sphere surface. In some embodiments, the frame may include vertical supports housing magnets configured to align the inner sphere to the default static orientation. In some embodiments, the apparatus may include buttons and rotatable inserts to visually represent three-dimensional orientations on the outer sphere surface.

In various embodiments, the azimuth and polar angular coordinates of the button on the outer sphere surface represent two Euler angles of orientation and a relative turn angle of the rotatable insert about the button axis represents a third Euler angle. In various embodiments, the apparatus may include a rotator assembly comprising a button, rotatable inserts, lock screw, swing arm, and cling head for performing controlled angular sweep rotations about the required pivot axis point on the sphere surface. In some embodiments, the outer sphere surface includes one or more of an anti-reflective coating, a non-wetting coating, or a removable overlay for recording spherical geometry drawings.

This and other aspects are described herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1A illustrates a front view of the assembled configuration of spherical geometry apparatus, according to one embodiment of the present subject matter.

FIG. 1B illustrates a side view of the assembled configuration of spherical geometry apparatus, according to one embodiment of the present subject matter.

FIG. 1C illustrates a top view of the assembled configuration of spherical geometry apparatus, according to one embodiment of the present subject matter.

FIG. 1D illustrates an oblique view of the assembled configuration of spherical geometry apparatus, according to one embodiment of the present subject matter.

FIG. 2A and FIG. 2B illustrate a side view and a front view of exploded configuration of the spherical geometry apparatus, according to an embodiment of the present subject matter.

FIG. 2C and FIG. 2D illustrate oblique views of exploded configuration of the spherical geometry apparatus, according to an embodiment of the present subject matter.

FIG. 3 illustrates a graph template on the inner sphere surface.

FIG. 4A and FIG. 4B illustrate oblique views of the semi-circular band element, according to an embodiment of the present subject matter.

FIG. 5A-FIG. 5C illustrate different views of the exploded configuration of the rotator assembly, according to an embodiment of the present subject matter.

FIG. 5D-FIG. 5F illustrate different views of the assembled configuration of the rotator assembly, according to an embodiment of the present subject matter.

Referring to the drawings, like numbers indicate like parts throughout the views.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The present subject matter describes an apparatus for practising spherical geometry and three-dimensional orientation concepts.

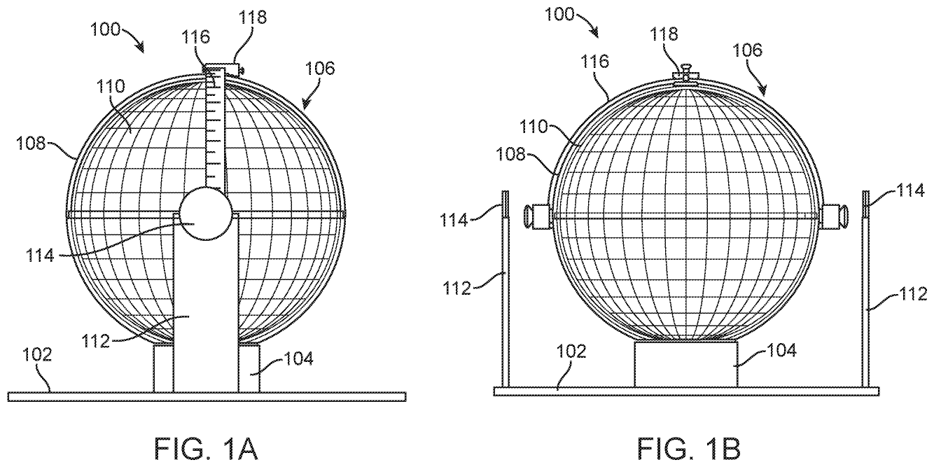

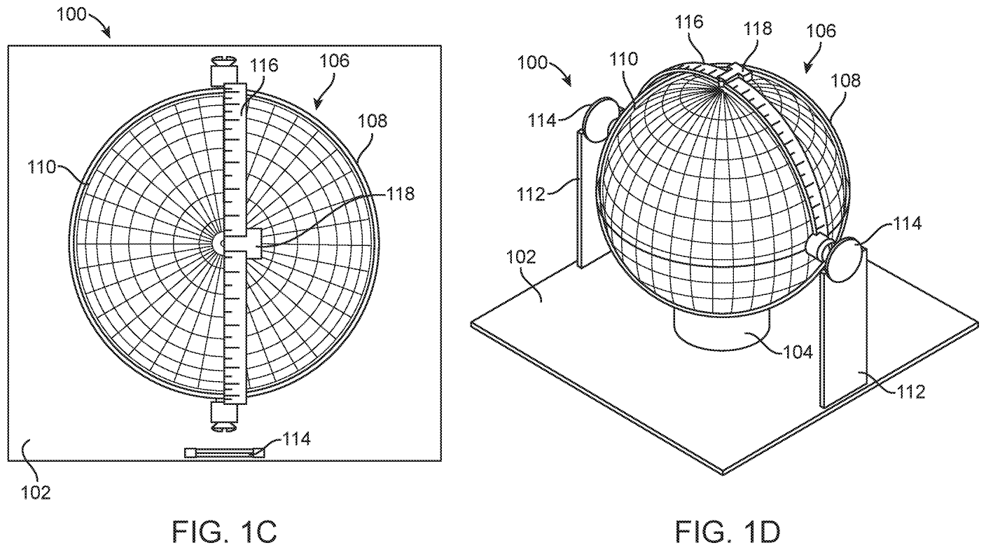

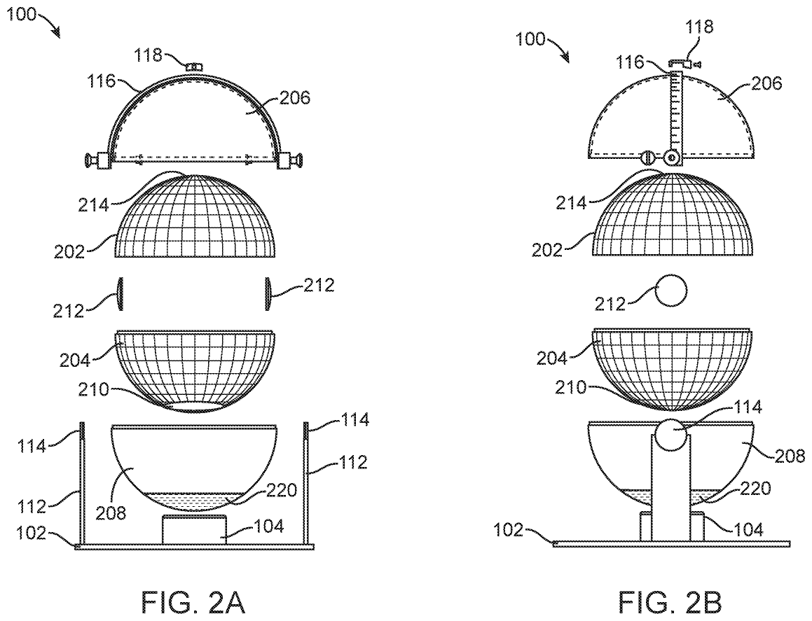

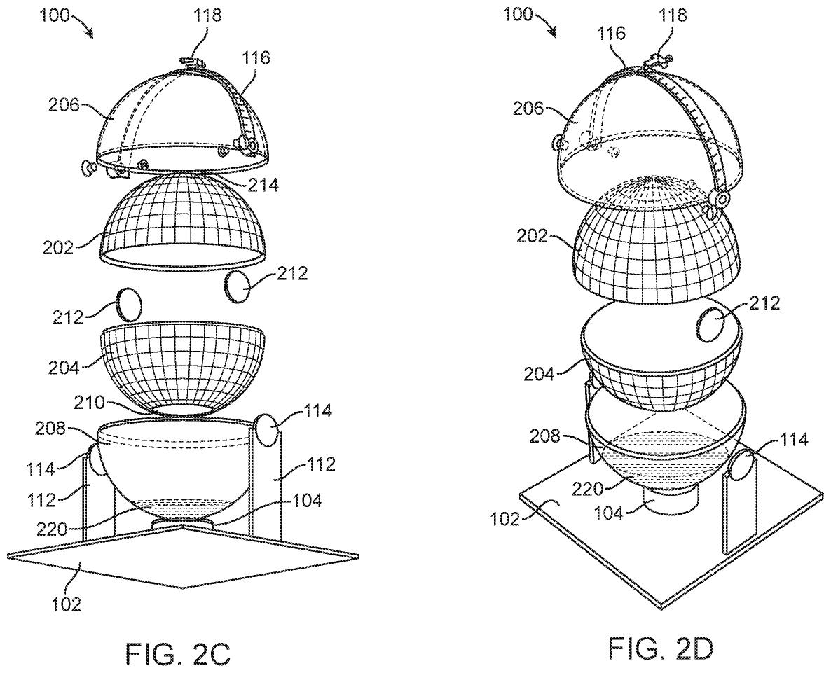

Assembled views of the spherical geometry apparatus are illustrated in FIG. 1A—FIG. 1D, according to various embodiments of the present subject matter. The spherical geometry apparatus 100 may include a frame 102 having a base 104 and a sphere set 106 placed on the base 104. The frame 102 may be a stationary and stable platform configured to mount all the external and internal components of the spherical measurement apparatus. In various embodiments, the frame 102 may be of square plate, cube, cuboid, or any other shape. The frame 102 may have embedded spirit level device, leveling screws, or may be engaged and clamped to floor base or other permanent structures.

The sphere set 106 may be a concentric double-sphere configuration, which may include an outer sphere 108 with a thin shell thickness, and an inner sphere 110. The outer sphere 108 may be transparent or semi-transparent, and the inner sphere 110 may include a surface representing a graph template. In various embodiments, the graph template may include azimuth and polar angle scales. In various embodiments, the spheres may be made up of plastic, glass or other suitable material.

The inner sphere 110 may be held in a default static orientation with reference to the base 104 and is concentric with reference to the outer sphere 108 by a levitating arrangement. In various embodiments, the levitating arrangement may include one or more of a predetermined liquid placed within the outer sphere, weights, or a plurality of internal magnets placed within the inner sphere 110. In various embodiments, the frame 102 may include vertical supports 112 housing external magnets 114 configured to align the inner sphere to the default static orientation. The outer sphere 108 may be supported on the base 104 and rotatable in any direction independent of the inner sphere 110 for determining spherical geometry measurements based on the graph template. In various embodiments, the base 104 may be a cylindrical body having a with a central hole or concave depression to accommodate with the sphere set surface.

In some embodiments, the external magnet arrangement may be absent, single or optional, or may be an electromagnet instead of a permanent magnet. In various embodiments, the internal and external magnet arrangement could be at a different horizontal height, well below the mid-height level of the sphere set, for unobstructed viewing and handling of the sphere set. In other embodiments, the internal and/or external magnet may be spread out on the entire horizontal ring instead of the two individual disc magnets of the present embodiment. In alternate embodiments, the internal/external magnet disc may consist of multiple sectors of magnetic and non-magnetic zones and the internal and external magnets could be aligned to latch the relative orientations of the two spheres.

In various embodiments, the apparatus may include a semi-circular band element 116 having an angular scale surface as shown in FIG. 1A-1D. The semi-circular band element 116 may be attached to antipodal points of the outer sphere 108. In various embodiments, the semi-circular band element 116 may be attached to the outer sphere 108 at a half-tight position to enable encircling motion on the outer sphere 108 surface. The apparatus 100 may also include a slidable component 118 movably coupled to the semi-circular band element 116. In some embodiments, the slidable component 118 may include a pointer hole attachable to a drawing tool, which may be configured for drawing arced paths of great circles and small circles.

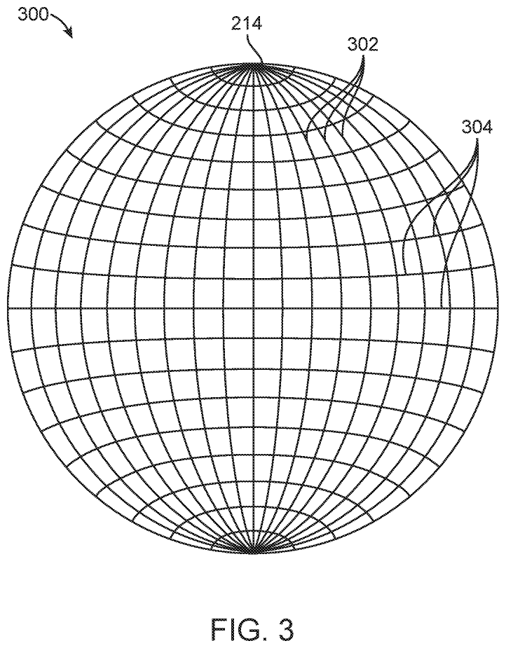

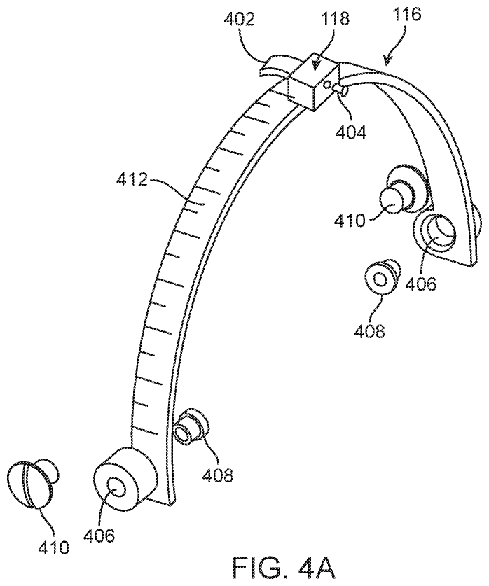

The exploded views of the spherical geometry apparatus are illustrated in FIG. 2A-FIG. 2D, according to various embodiments of the present subject matter. The apparatus 100 is a concentric double-sphere design configuration including a floating inner sphere 110 that retains a static orientation inside the outer sphere 108. As shown, the inner sphere 110 may include an upper inner hemisphere 202 and a lower inner hemisphere 204, and the outer sphere 108 may include an upper outer hemisphere 206 and a lower outer hemisphere 208. In various embodiments, the upper inner hemisphere 202 and the lower inner hemisphere 204, and likewise, the upper outer hemisphere 206 and the lower outer hemisphere 208, may be attached using one or more permanent or semi-permanent joining mechanisms. For example, the permanent joining mechanisms may include adhesive bonding, welding, brazing, soldering, and the like. The semi-permanent or temporary joining mechanisms may include snap-fitting, male-female coupling, nuts, bolts, washers, knock-down fitting, and the like.

The inner sphere 110 may be stabilized using a weight 210, which may be fixed at the bottom of the lower inner hemisphere 204. In various embodiments, the junction of the upper and lower inner hemispheres may also be attached together along with a pair of horizontal magnets 212. The pair of magnetics 212 may be positioned diametrically opposite to each other inside the inner sphere 110. In some embodiments, the pair of magnets 212 and the vertical support housing magnets 114 may be positioned horizontally at a predetermined height so as to magnetically align and lock the inner sphere orientation. The combination of the weight 210 and the horizontally aligned magnetic forces ensure that the inner sphere 110 retains a default static orientation even as the outer sphere 108 is rotated arbitrarily.

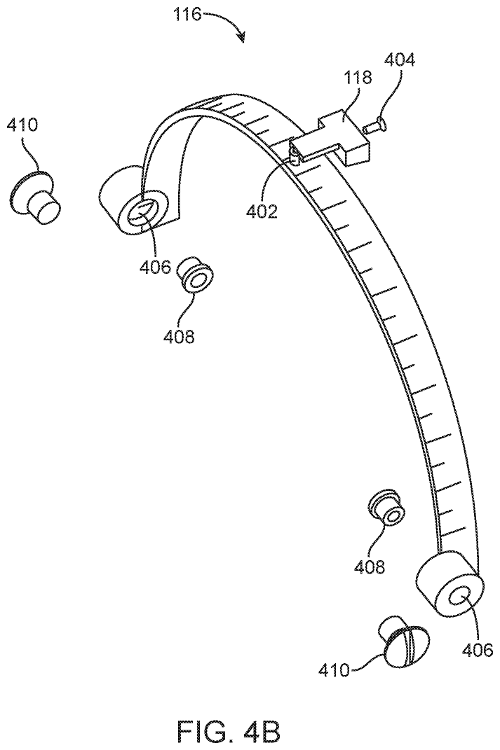

In various embodiments, the graph template on the inner sphere surface 110 may include precise markings of polar and azimuth angles with the apex point 214 defined as the origin. An embodiment of the graph template is illustrated in FIG. 3. As shown, the longitude type of great circles 302 pass through the origin point 214 at predetermined azimuth angle intervals. The latitudes of small circles 304 may be at periodic intervals of polar angle. The underlying graph template including the spherical angle scale is visible through the transparent outer sphere. In some embodiments, the outer sphere surface 108 may include one or more of an anti-reflective coating, a non-wetting coating, or a removable overlay for recording spherical geometry drawings. In other embodiments, the outer sphere may be partly transparent, could carry additional surface details, such as partly transparent Earth globe maps, or may allow removable overlay of hemispherical tracing papers for recording and storing the spherical geometry drawings. The graph template 300 may function as a graph paper for constructing geometrical drawings on the outer sphere surface 108.

Referring back to FIG. 2A-FIG. 2D, the lower outer hemisphere 208 is configured to hold a predetermined quantity of liquid, such as water, which is displaced to the annular gap region by the floating inner sphere 110. In some embodiments, the liquid may be spirit or any combination of fluids. The spherical set 106 may be freely rotatable by hand so that any desired surface point of the outer sphere 108 may be brought to the top and align above the origin point 214 of the inner sphere 110. With this point as reference, the relative separation distance or the great circle distance of other surface points of the outer sphere 108 may be determined from the polar angle coordinate values. The two spheres lie concentric and by viewing the surface point perpendicularly along the radial line, the angular coordinates of the outer surface point may be precisely obtained avoiding the parallax effect. The angle between intersecting great circles or their arcs on the outer sphere is measured by bringing the intersecting point to the apex location 214 and measuring the azimuth angle contained between the arcs.

In some embodiments, the graph template may include celestial sphere map, and the outer sphere surface may represent globe map, or vice-versa. The outer sphere may be rotated and the global-celestial positions aligned based on the date, time information. In one embodiment, the relative orientation of the spheres may then be locked by clamp aligning the internal and external sector-zoned magnets, and the resulting sphere assembly may be used to infer the sky map across different locations of the globe.

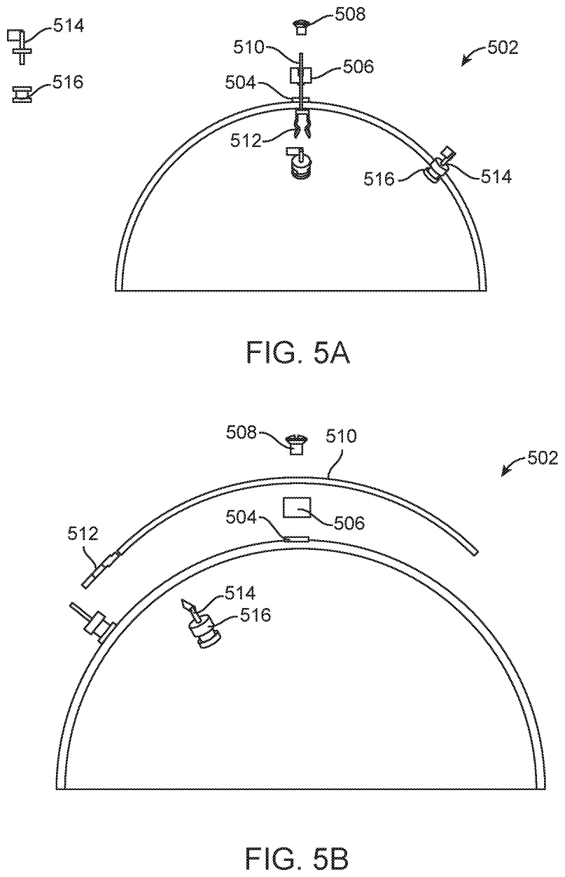

Oblique views of the semi-circular band element 116 are illustrated in FIG. 4A and FIG. 4B, according to an embodiment. The inner curvature of the band element 116 nearly matches with the outer sphere surface 108. One of the band element's side circumferential edge may be aligned with the sphere circumferential path for tracing a great circle path. The band element 116 holding onto the outer sphere surface 108 may be configured to perform multiple functions including, but not limited to, measuring angular distances, joining points by great-circle shortest paths, and sweeping arcs of great and small circles.

In various embodiments, a small curved transparent slidable component 118 fits over the band element 116 with a small clearance. The slidable component may include a pointer hole 402 that may operate as a guide for a tip of pen, marker, or any other drawing tool. The slidable component 118 may be rigidly engaged to the band 116 at a location by a lock screw mechanism 404. The two ends of the band element 116 may include provision for precisely and sturdily holding or gripping the desired opposite pair pivot points of the outer spherical surface 108. In various embodiments, the band element 116 may include a ruler 412 and a set of pivot hole 406, gripper element 408, lock screw 410 at its ends. The band element 116 may be seated on the sphere from top and adjusted, and the pivot hole 406 at the gripper ends may be configured to visually seek and ascertain the grip point on the sphere surface 108. The lock screw 410 may be fastened along the threaded section of the hole to slide out the disk-shaped gripper 408 towards the grip position of sphere surface 108.

When the lock screws 410 are half-tightened, the band element 116 grips fixedly and allows encircling motion about the pivot axis 406, and thus functions as a drafting compass for the slide pointer 402 to sweep circular arcs on the sphere 108. With further tightening of lock screw 410, the band 116 is rigidly held on the sphere 108, and the slide pointer 402 may be configured to trace great circle arc along the ruler edge of the band 116. The ruler 412 may include markings on the outer thickness side for angle measurement along the circumference.

The sphere set 106 may be seated stably on a short vertical hollow cylindrical base 104, which may be fixed on a steady platform 102. The instrument platform 102 may carry two vertical support structures 112. In various embodiments, the vertical support structures 112 may be elevated to the middle level of the seated sphere set 106. The vertical support structures 112 may include disc shaped magnets 114, which may be fixed at the same height as the pair of magnets in the sphere set in parallel alignment of magnetic poles. The arrangement of stronger magnetic field may allow quick steadying of magnetic orientation of the inner sphere 110, compared to the earth's weak magnetic field that is susceptible to stray interferences from magnetic materials in the surrounding environment.

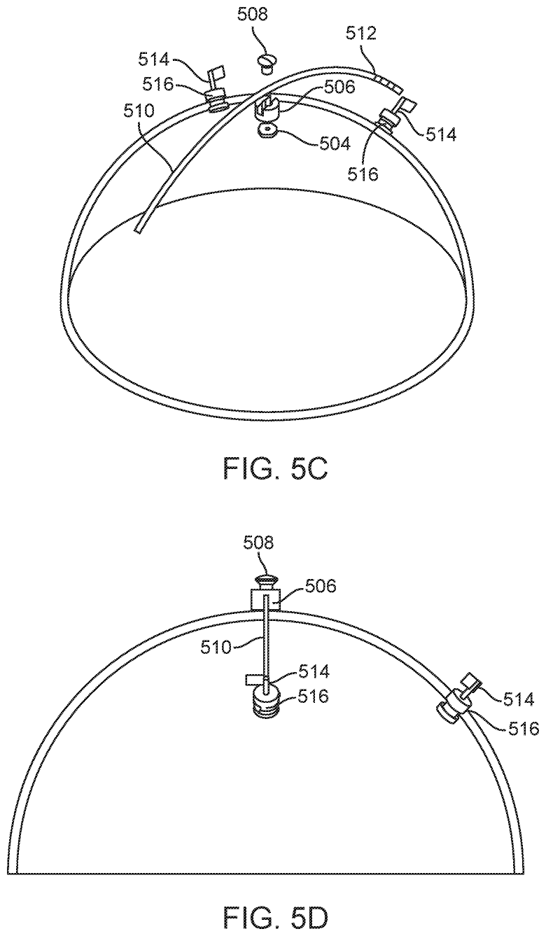

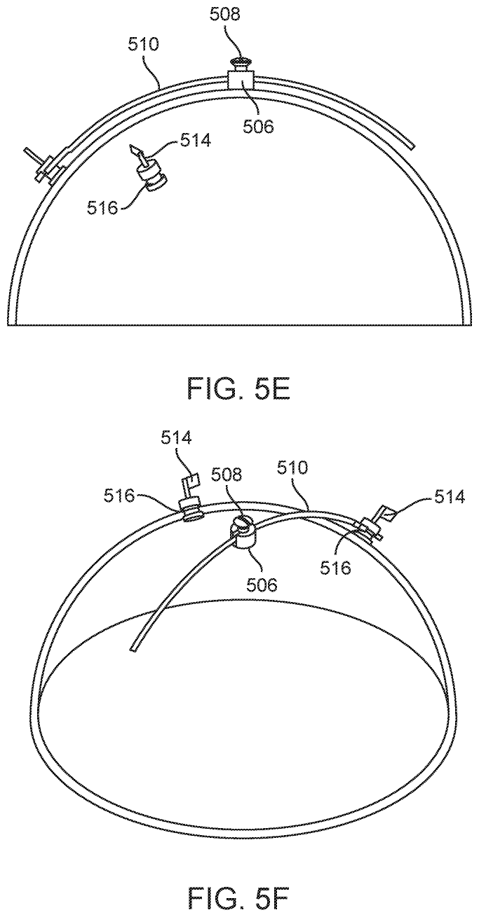

The apparatus may include a rotator assembly as illustrated in FIG. 5A-FIG. 5F, according to various embodiments of the present subject matter. As shown, the rotator assembly 502 may include a button 504, rotatable inserts 506, lock screw 508, swing arm 510, and cling head 512 for performing controlled angular sweep rotations about the required pivot axis point on the sphere surface. In some embodiments, the rotator assembly 502 may include rotatable inserts of artefact models 514 and adherable buttons 516, configured to visually represent three-dimensional orientations on the outer sphere surface 108. The base of the adherable buttons may have concavity matching with the sphere radius, and can be fixed to the sphere surface via a thin double-sided tape. In various embodiments, the artefact models 514 may be any object, such as flag, aeroplane, crystal, creature or other models of users' interest.

The visual representation obtained using artefact models 514 and adherable buttons 516 may be used for quantitative measurement of Euler angles of orientation of artefact model on sphere surface and visually elucidate stepwise Euler angle rotations. In various embodiments, the azimuth and polar angular coordinates of the button on the outer sphere surface 108 represent two Euler angles of orientation and a relative turn angle of the rotatable insert about the button axis represents a third Euler angle.

In the button and insert model assembly, the direction or sense of the vertical insert axis of model may be derived from the angular position of the button on the sphere surface 108. The range of azimuth and polar angles on the sphere surface cover the complete set of possible orientations for the model insert axis, and these respectively correspond to the first and second Euler angles of orientation. Whereas, the relative in-plane rotation of the insert model 514 on the button 516 determines the third Euler angular value of orientation, and an orthogonal reference direction of the model such as the flag fly with respect to flag pole is conveniently chosen for assessing the in-plane rotation angle.

The button positioned at the apex origin point 214 denotes the default upright orientation of model insert axis. Further, when the orthogonal direction (such as the fly direction of flag model) points towards the azimuth angle meridian of zero degree, the model is assumed to be at default reference 3D orientation with all Euler angle values as zero. In case of an arbitrarily placed model on the sphere surface, the first two Euler angle of its orientation are determined from the azimuth and polar angular positions on the sphere. By reverse angular rotations of the sphere by azimuth and polar angles, the model moves to the apex point 214 of the inner sphere 110, and the third Euler angle is then determined by measuring the relative turn angle of rotation of the reference orthogonal direction from the zero-degree azimuth angle meridian.

In some embodiments, the rotatory assembly may be configured for picking up an artefact model button on sphere surface, executing precise rotation operation so as to physically view the resultant change in orientation of the model to the new state. The rotator assembly set 502 may be used for making quantitative rotation procedures for changing the orientation of the insert button 516. The quarter-circular ring-shaped strip element with a circlip shaped head 512 that can cling and snatch on to the model button base, forms the swing arm 510 of the rotator. The swing arm strip may be configured to slide on the slotted path on the rotator insert 506 so that the model button 516 is at a required angular distance from the rotator button 504 point, and held tight at that position by a lock screw 508. Similar to the model button 514, the rotator insert 506 can slid onto its button 504 piece and rotate, and the assembly may be affixed on the sphere surface using the double-sided adhesive tape.

The rotator button 504 then becomes the pivot point for the rotation action of the swinging arm. When the rotator button 504 is positioned above the apex point 214 of inner sphere 108, the azimuth angle of the swinging arm may be observed and monitored to make controlled rotation of the model through the desired rotation angle. The rotation operation brings about the change in orientation of the model from initial state to the final state, and the rotation path, angle of mis-orientation is physically evident with the aid of this apparatus.

The apparatus provides a comprehensive spherical geometry educational device based on a double-sphere configuration, which includes retaining a steady default orientation in the inner sphere, so as to utilize its static orientation and its angle graduated surface as the background graph for measuring and drawing spherical angles on the outer transparent sphere. The apparatus provides methods or physical elements for effecting independent rotation so as to bring about a change in 3D orientation of an artefact on a spherical surface. Further, the apparatus includes simple components and is easy to manufacture.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention without departing from the spirit and scope of the invention as described here.

I claim:

1. An apparatus (100) for performing spherical geometry, the apparatus (100) comprising:
a frame (102) having a base (104);
a sphere set (106) placed on the base (104), the sphere set (106) comprising a thin outer transparent sphere (108) and an inner sphere (110) having a surface representing a graph template, the graph template comprising azimuth and polar angle scales, wherein:
the inner sphere (110) is held in a default static orientation with reference to the base (104) and to be concentric with reference to the outer sphere (108) by a levitating arrangement;
the outer sphere (108) supported on the base (104) as to be rotatable in any direction independent of the inner sphere (110) for determining spherical geometry measurements based on the graph template.

2. The apparatus (100) as claimed in claim 1, wherein the levitating arrangement comprises one or more of a predetermined liquid placed within the outer sphere (108), weights, or a plurality of magnets (212) placed within the inner sphere (110).

3. The apparatus (100) as claimed in claim 1, comprising a semi-circular band element (116) having an angular scale surface, wherein the semi-circular band element (116) is attached to antipodal points of the outer sphere (108).

4. The apparatus (100) as claimed in claim 3, comprising a slidable component (118) movably coupled to the semi-circular band element (116).

5. The apparatus (100) as claimed in claim 4, wherein the slidable component (118) comprises a pointer hole (420) attachable to a drawing tool, wherein the drawing tool is configured for drawing arced paths of great circles and small circles.

6. The apparatus (102) as claimed in claim 3, wherein the semi-circular band element (116) is attached to the outer sphere at a half-tight position to enable encircling motion around the outer sphere (108).

7. The apparatus (100) as claimed in claim 1, wherein the frame (102) comprises vertical supports (112) housing magnets (114) configured to align the inner sphere (110) to the default static orientation.

8. The apparatus (100) as claimed in claim 1, comprising buttons (504) and rotatable inserts (506) to visually represent three-dimensional orientations on the outer sphere surface (108).

9. The apparatus (100) as claimed in claim 8, wherein the azimuth and polar angular coordinates of the button on the outer sphere surface (108) represent two Euler angles of orientation and a relative turn angle of the rotatable insert about the button axis represents a third Euler angle.

10. The apparatus (100) as claimed in claim 1, comprising a rotator assembly (502) comprising a button (504), rotatable inserts (506), lock screw (508), swing arm (510), and cling head (512) for performing controlled angular sweep rotations about the required pivot axis point on the sphere surface.

11. The apparatus (100) as claimed in claim 1, wherein the outer sphere surface (108) comprises one or more of an anti-reflective coating, a non-wetting coating, or a removable overlay for recording spherical geometry drawings.
